(19) United States
(12) Patent Application Publication
(10) Pub. No.: US 2006/0121343 A1
(43) Pub. Date: Jun. 8, 2006

(54) Battery protective packaging structure

(76) Inventor: Chia-Hsien Shu, Taoyuan (TW)

Correspondence Address: LEONG C LEI, PMB # 1008, 1867 YGNACIO VALLEY ROAD, WALNUT CREEK, CA, 94598, US

(21) Appl. No.: 11/003,358

(22) Filed: Dec. 6, 2004

(51) Int. Cl. H01M 2/00

(52) U.S. Cl. 429/163

(57) ABSTRACT

A battery packaging structure is provided. In this structure, high-strength protective covers are used so as to withstand external forces and internal inflation. The protective cover is made by an enhanced integration of metallic plate and plastic material. The use of metallic plate not only enhances the rigidity of the battery packaging, but also offers better and faster heat dissipation. The integration of metallic and plastic materials could also effectively prevent battery deformation and stabilize product quality.

### BACKGROUND OF INVENTION

(a) Technical Field of the Invention

The present invention generally relates to batteries and, more particularly, to a protective battery packaging structure.

(b) Description of the Prior Art

Battery is an indispensable element for all kinds of consumer electronic devices. From as small as a mobile handset to as large as a notebook computer, batteries are their source of lives. Batteries not only provide the electrical power these devices need, but also make these devices mobile and portable.

Conventionally, batteries are usually wrapped in plastic protective covers. The plastic covers are injection-molded and then adhered to each other using supersonic adhesion. As the power of the batteries are continuously increased, problems such as excessive charging and discharging frequently happens. Under these circumstances, the batteries would dissipate heat and inflate and, in the worst case, the batteries would inflate severely and decompose. The protective covers, therefore, have been the safeguard to the batteries. The packaging structure of the batteries' protective covers is highly related to the batteries' safety, quality, and stability.

More advanced battery packaging structures have been proposed. The protective covers are made by a combination of metal and plastic. As shown in FIGS. 1 and 2, the protective covers mainly contain a metallic plate A1 whose sides are arranged and bended to have an array of fences A2. The fences A2 are injection-molded with plastic A3 so that the fences A2 are wrapped in plastic A3 to become a protective cover A10. FIG. 2 is a side view of a conventional battery packaging. As shown in FIG. 2, two symmetrical protective covers A10 wrap a battery there between. The plastic A3 of the protective covers A10 are then sealed together by supersonic adhesion. This type of battery packaging has limited robustness as there is no adequate mechanism for locking the fences A2 and the plastic A3 together, which is the major factor for the fragility of conventional battery packaging.

Accordingly, there is a need for a better battery packaging structure so that the robustness of the battery could be enhanced and the decomposition of the battery could be prevented.

### SUMMARY OF THE INVENTION

The primary purpose of the present invention is to provide a battery packaging structure having the following characteristics.

First, high-strength protective covers are used so as to withstand external forces and internal inflation.

Secondly, the integration between metallic and plastic materials is enhanced. In addition, metallic plates are adopted for better and faster heat dissipation.

At last, the integration of metallic and plastic materials could effectively prevent battery deformation and stabilize product quality.

A major feature of the present invention is to utilize a locking mechanism to enhance the integration between the metallic protective cover and the plastic. In the battery packaging structure according to the present invention, the metallic protective covers are bended at their four sides and triangular clasps are arranged along the bended rims so as to lock the plastic tightly together with the metallic protective cover when they are injection-molded together. The clasp is formed by punching inward or outward a triangular plate out of the bended rim. The triangular plates of the clasps are arranged to alternate their pointing directions (inward or outward).

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a metallic plate of a conventional battery packaging.

FIG. 2 is a side view of a conventional battery packaging.

FIG. 3 is a perspective view of a battery packaging according to a preferred embodiment of the present invention.

FIG. 4 is a perspective explosion view of a battery packaging according to a preferred embodiment of the present invention.

FIG. 5 is a perspective view of a metallic plate of a preferred embodiment of the present invention.

FIG. 6 is an enlarged view of a part of the metallic plate depicted in FIG. 5.

FIG. 7 is a side view of a battery packaging according to a preferred embodiment of the present invention.

FIG. 8 is an enlarged view of a part of the battery packaging depicted in FIG. 7.

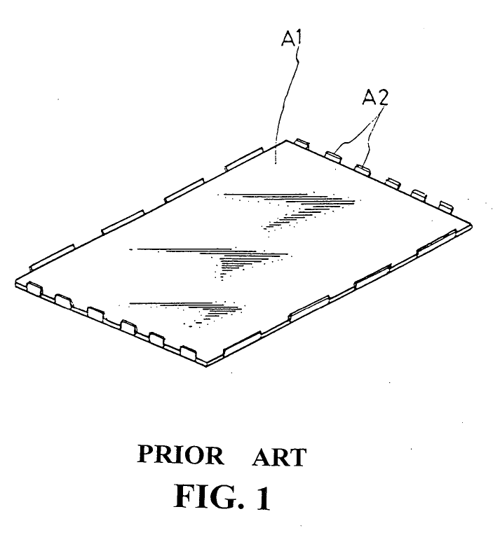

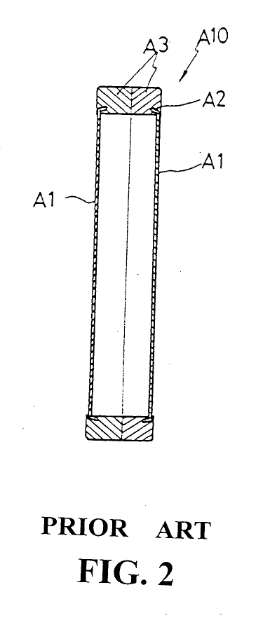

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In the following, detailed description along with the accompanied drawings is given to better explain preferred embodiments of the present invention.

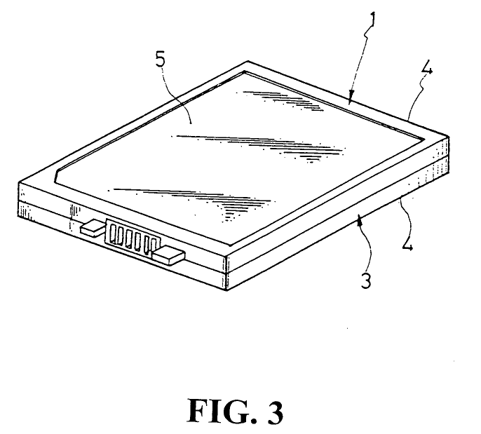

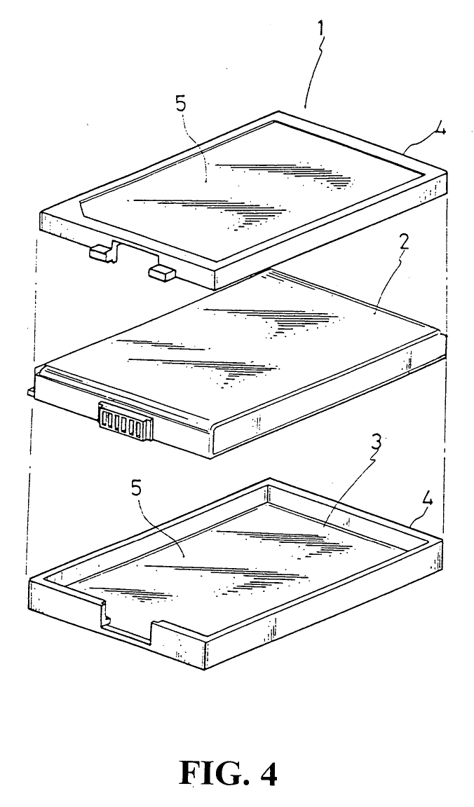

Please refer to FIGS. 3 and 4. The present invention contains a top cover 1, a battery 2, and a bottom cover 3. The battery 2 is sealed between the symmetrical and corresponding top and bottom covers 1 and 3 by bonding the plastic rims 4 of the top and bottom covers 3 and 4 together with supersonic adhesion.

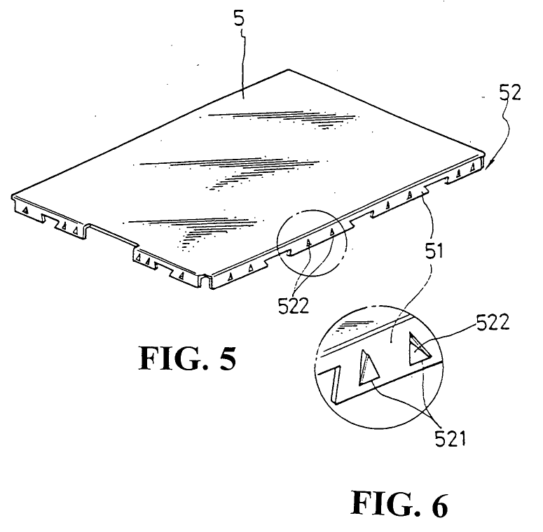

Please also refer to FIG. 5. The symmetrical and corresponding top and bottom covers 1 and 3 are both composed of a metallic plate 5 and a plastic rim 4 injection-molded along the circumference of the metallic plate 5. The metallic plate 5 is manufactured using stamping and the edges of its sides are folded into bended rims 51. Along the bended rims 51, there is an array of horizontally arranged clasps 52, which tightly grasps the plastic rim 4 when the plastic rim 4 is injection-molded along the circumference of the metallic plate 5.

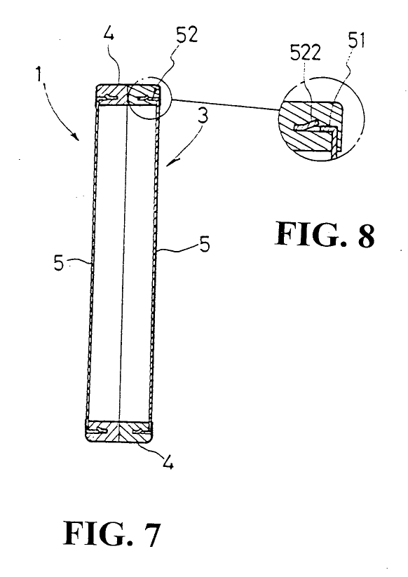

As shown in FIGS. 6, 7, and 8, the clasp 52 is made by punching inward or outward a triangular plate 522 out of the bended rim 51. The triangular plate 522 is still attached to the bended rim 51 at the triangular plate 522's bottom edge 521. It is this triangular plate 522 that tightly grasps the plastic rim 4 when the plastic rim 4 is injection-molded along the circumference of the metallic plate 5. The clasps 52's tightly coupling with the plastic rims 4 assists the metallic plate 5 to withstand external forces or internal inflating stresses.

Based on the foregoing description, the major feature of the present invention lies in the wrapping the clasps 52 inside the injection-molded plastic rims 4, whose tight coupling helps to enhance the robustness of the battery packaging. Please note that the triangular plate 522 could be pointed into the bended rim 51, or pointed outward from the bended rim 51. In another embodiment, the triangular plates 522's could alternate their pointing directions (i.e., one points inward, the next one points outward, and so on). In addition, the clasps 52 could also have other shapes other than a triangle. It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A battery protective packaging structure, comprising:
a top cover;
a bottom cover; and
a battery,
said battery protective packaging structure characterized in said top and bottom covers both comprising a metallic plate and an injection-molded plastic element bonded together with said metallic plate, said battery sealed between said top and bottom covers, said top and bottom covers adhered to each other using supersonic adhesion, said metallic plate manufactured by stamping, said metallic plate having its sides folded into bended rims, said bended rims having a plurality of clasps on a surface of said bended rims, said clasps having a side attached to said bended rims, said clasps interleaving their pointing directions, and said clasps tightly coupled with said plastic when said clasps are wrapped in said plastic by injection molding.

2. The structure according to claim 1, wherein said clasps are all pointed into an inner side of said bended rims.

3. The structure according to claim 1, wherein said clasps are all pointed toward an outer side of said bended rims.
